(19) United States
(12) Patent Application Publication
(10) Pub. No.: US 2025/0135471 A1
(43) Pub. Date: May 1, 2025

(54) CENTRIFUGE AND METHOD FOR ADJUSTING CENTER OF GRAVITY OF ROTOR OF CENTRIFUGE

(71) Applicant: RORZE Lifescience Inc., Ibaraki (JP)

(72) Inventors: Takashi KANNO, Ibaraki (JP); Hiromu MAIE, Ibaraki (JP)

(21) Appl. No.: 18/607,568

(22) Filed: Mar. 18, 2024

Related U.S. Application Data
(63) Continuation of application No. PCT/JP2023/039280, filed on Oct. 31, 2023.

(51) Int. Cl. B04B 9/14; B04B 13/00

(52) U.S. Cl. CPC B04B 9/146; B04B 13/00

(57) ABSTRACT

There is provided a centrifuge including a rotor including a weight movement mechanism that supports a solid adjustment weight to be movable along a radial direction on an opposite side in the radial direction from an end portion of the rotor by which a specimen to be centrifuged is held; and a center-of-gravity adjustment unit disposed at a position away from the rotor to be connectable to the rotor, and including a weight drive mechanism connected to the weight movement mechanism to move the adjustment weight on the rotor. The center-of-gravity adjustment unit calculates a movement amount or a movement position of the adjustment weight according to an input weight of a container storing the specimen, and moves the adjustment weight.

### RELATED APPLICATIONS

The present application is a continuation of International Application No. PCT/JP2023/039280, filed Oct. 31, 2023, the disclosure of which application is hereby incorporated by reference here in its entirety.

### TECHNICAL FIELD

The present invention relates to a centrifuge including a mechanism that adjusts the rotational balance of a rotor by adjusting the center-of-gravity position of the rotor, and a method for adjusting the center of gravity of a centrifuge in which the rotational balance of the rotor is adjusted by adjusting the center-of-gravity position of the rotor of the centrifuge.

### BACKGROUND ART

A centrifuge is a device that performs the separation, concentration, purification, and analysis of a substance in a liquid or powder using a centrifugal force. A centrifuge obtains a centrifugal force by rotating a centrifuge tube, a tube (Eppendorf tube or the like), a plate (microwell plate or the like), and the like in which a specimen or a sample to be processed (hereinafter, simply referred to as a “specimen”) is contained at high speed (in the following description of the invention, the centrifuge tube, the tube, the plate, and the like are collectively referred to as a “tube” or a “container”). For that reason, generally, after the specimen is set at one end of the rotor (a rotating body in which the specimen is set: in the present specification, hereinafter, simply referred to as a “rotor”), the balance of the rotor during rotation is maintained by setting a tube or a plate, which is adjusted to have the same weight as the specimen, on an opposite side of the rotor from the side on which the specimen is set.

However, in the field of cell culture, the weight of the specimen differs for each centrifugation processing in many cases. For that reason, each time the centrifuge is used, a tube or a plate having the same weight as the specimen on which centrifugation is performed is adjusted, which has become a large burden on users of the centrifuge in the field of cell culture.

A centrifuge capable of automatically adjusting rotational balance without adjusting and setting a specimen and a tube or a plate having the same weight as the specimen at both ends of a rotor is disclosed in JP 3809952 B2 (Patent Document 1) and JP 2010-64012 A (Patent Document 2). The automatic balancing centrifuge disclosed in Patent Document 1 is configured such that lever movement motors 252, 272, and 652 that move rotor levers 230, 240, and 630 leftward and rightward are provided inside the rotor and balance during rotation is automatically adjusted.

In addition, Patent Document 2 discloses a technique in which in order to automatically correct the balance of the weight of a rotor 4, the amount of a fluid 11 (for example, water) is adjusted to reduce vibration during rotation by supplying the fluid into cavities 10a and 10b inside the rotor from an inertia adjustment mechanism 5 externally provided (refer to paragraphs [0009] and [0017]). In Patent Document 2, the cavities serve as storage portions for the fluid, and a change in weight due to a change in the amount of the fluid inside the storage portions functions as a weight that adjusts the center of gravity to adjust balance.

### CITATION LIST

### Patent Document

Patent Document 1: JP 3809952 B2
Patent Document 2: JP 2010-64012 A

### SUMMARY OF THE INVENTION

### Problem to be Solved by the Invention

In the automatic balancing centrifuge disclosed in Patent Document 1, the lever movement motors are provided inside the rotor, and the center of gravity of the rotor is adjusted by moving the rotor levers in a left end or right end direction inside the rotor. However, since the lever movement motors are provided inside the rotor, the weight of the rotor that is a rotating body increases, and a drive load for rotational drive increases. In addition, since a motor for motor drive is disposed within a rotation mechanism, the balance design for the rotor in consideration of the shape, position, and weight of the motor becomes necessary, and also adjusting the rotational balance becomes difficult. In addition, increasing of the weight makes it difficult to adjust the balance when the rotor rotates at high speed, and the acceleration time until the rotor reaches a predetermined rotation speed and the braking time until the rotor comes to a stop also become longer.

In the specification of Patent Document 2, the structure, form, and material of the cavities (hereinafter, referred to as “storage portions” as appropriate) 10a and 10b, and the release of air inside the storage portions when the liquid is injected have not been clearly described. However, in a case where the storage portions (cavities) are formed of rigid bodies, in order to inject the liquid into the cavities, a vent hole or a ventilation adjustment mechanism for releasing of or suctioning air inside the storage portions corresponding to the amount of the liquid injected is required. A structure in which such a vent hole for air is provided has a risk of water leakage from the vent hole. Since the water leakage becomes a serious risk of contamination, it is preferable that the risk of water leakage in a centrifuge that performs cell culture or chemical analysis is eliminated as much as possible.

In order to avoid such a problem of the vent hole, the storage portions can also be formed into a flexible balloon shape in which the storage portions inflate or deflate according to the amount of the liquid injected, to receive the liquid. This configuration eliminates the need for ventilation such as releasing of or suctioning gas from the storage portions.

However, in the case of the storage portions having a balloon shape, since the storage portions need to be made of a flexible material that is inflatable or deflatable by the injection or suction of the liquid, the durability of the storage portions decreases, and a risk of liquid leakage increases, which is a problem.

In addition, when the storage portions serving as adjustment weights inflate or deflate, the three-dimensional shape of the storage portions changes, so that the balance adjustment of the rotor becomes complicated. Namely, since the storage portions inflate when the liquid is injected, not only the weight of the storage portions increases but also the volume increases corresponding to the amount of the liquid supplied, and the three-dimensional shape of the storage portions (balloons) changes. When the three-dimensional shape of the storage portions is changed by the amount of the liquid injected, the center-of-gravity positions of the storage portions (balloons) themselves that are weight adjustment bodies also change. Therefore, complicated balance adjustment taking into account not only a change in the weight (supply amount) of the liquid corresponding to the amount of the liquid injected, but also a change in the center-of-gravity positions of the storage portions themselves due to the supply is required.

In addition, in the centrifuge of Patent Document 2 that uses the liquid as a weight adjustment medium regardless of whether the storage portions are rigid bodies or have a flexible balloon shape, there is also a risk of liquid leakage from a mechanism portion of a rotary joint. As described above, in the fields of cell culture and chemical analysis, since a risk of contamination due to the liquid leakage is hated, the risk of liquid leakage needs to be avoided as much as possible. Since a rotary joint with high accuracy and durability capable of reliably preventing liquid leakage has a complicated structure and is also increased in cost, the centrifuge that adopts a liquid as a weight balancer as in Patent Document 2 has various problems.

The invention has been made in view of the above-described problems, and an object of the invention is to provide a centrifuge and a method for adjusting the balance of a centrifuge capable of adjusting the center of gravity of a rotor by automatically moving the position of a solid adjustment weight according to the weight of a specimen without providing a drive source, which drives the weight, inside the rotor, having little risk of contamination, and capable of obtaining stable rotational balance.

### Means for Solving Problem

In order to achieve the above-described object, according to a first aspect of the invention, there is provided a centrifuge including: a rotor rotationally driven around a predetermined axis, supporting a bucket at one end in a radial direction of a rotation around the axis, the bucket holding a container storing a specimen, and supporting a solid adjustment weight to be movable in the radial direction on the other end side in the radial direction, the adjustment weight adjusting a rotational balance by adjusting a center of gravity of the rotor; a rotor drive motor to rotationally drive the rotor; a center-of-gravity adjustment unit provided at a position away from the rotor to be selectively coupleable to the rotor, and coupled to drive the adjustment weight to move in the radial direction when the center of gravity is adjusted; and a control unit to control operations of the center-of-gravity adjustment unit and the rotor drive motor.

According to this aspect, the weight of the rotor can be reduced by separately providing the center-of-gravity adjustment unit to be coupleable to the rotor. In addition, since the rotor does not include a drive unit, the structure of the rotor is simple, and the adjustment of the center of gravity of the rotor is facilitated. For that reason, vibration during high-speed rotation can also be suppressed, and the rotational balance can also be stabilized. Furthermore, a drive load when the rotor starts rotating can be suppressed, and the braking time when the rotation is started and stopped can also be reduced.

In another aspect of the centrifuge of the invention, the center-of-gravity adjustment unit includes a weight drive mechanism to drive the adjustment weight in the radial direction, and a coupling mechanism to move the weight drive mechanism to couple or separate the rotor and the weight drive mechanism from each other such that the adjustment weight can be driven, and the control unit calculates drive data for moving the adjustment weight based on input data regarding a weight of the specimen to be centrifuged, and controls the weight drive mechanism based on the drive data.

As a drive source of the weight drive mechanism and a drive source of the coupling mechanism, various types of drive means such as a motor, hydraulic drive, and drive by high-pressure air can be used. The weight drive mechanism includes a weight drive unit to drive the adjustment weight, and a coupling end portion on a drive side to couple the weight drive unit and the rotor to each other. The rotor includes a coupling end portion on a rotor side connected to the coupling end portion on the drive side. In a case where the weight drive unit is a motor, the coupling end portion on the drive side can be connected to a rotating shaft of the motor directly or indirectly via gears or the like.

The control unit calculates drive data for moving the adjustment weight to a position where a center-of-gravity position of the rotor when the specimen is set in the rotor coincides with a rotation center of the rotor, and controls a driving of the coupling mechanism and the weight drive mechanism to couple the weight drive mechanism to the rotor and then to move the adjustment weight to the center-of-gravity position based on the drive data.

The drive data can be calculated from the mass of the adjustment weight, a distance from the rotation center to the center-of-gravity position of the adjustment weight, and the weight of the specimen. Incidentally, the term “calculate” is used in the sense of also including reading and acquiring data from a table recorded in advance. For example, the drive amount (for example, the rotation amount of a motor in a case where the drive source is a motor) of the adjustment weight for each weight of the specimen is stored in a table, a drive amount corresponding to the weight of the specimen is read from the table, and the value of the drive amount can be used as the drive data. The drive amount in this case can be defined as a drive amount from a predetermined reference position.

According to the second aspect of the invention, there is provided a method for adjusting a center of gravity of a rotor of a centrifuge including a rotor rotationally driven around a predetermined axis, supporting a bucket at one end in a radial direction of a rotation around the axis, the bucket holding a container storing a specimen, and supporting a solid adjustment weight to be movable in the radial direction on the other end side in the radial direction, the adjustment weight adjusting a rotational balance, a center-of-gravity adjustment unit disposed at a position away from the rotor to be connectable to the rotor, and to move the adjustment weight in any direction of the radial direction, and a control unit to control an operation of the center-of-gravity adjustment unit, the method including: (a) a data input step of inputting data regarding a weight of the container storing the specimen; (b) a calculation step of calculating a movement amount of the adjustment weight based on the data; (c) a step of connecting the center-of-gravity adjustment unit to the rotor before both or one of the step (a) and the step (b) is executed, after the execution, or during the execution; and (d) an adjustment step of adjusting a center-of-gravity position of the rotor by moving the adjustment weight based on the movement amount calculated in the step (b) after all the steps (a) to (c) are executed.

### Effect of the Invention

According to the invention, the solid adjustment weight for adjusting the center of gravity is provided at the one end of the rotor to be movable in the radial direction, and the weight drive mechanism that changes the center-of-gravity position of the rotor is provided outside the rotor, so that the center of gravity can be changed by coupling the rotor and the weight drive mechanism to each other only when the center of gravity is changed. Accordingly, the rotational balance of the rotor can be automatically adjusted without significantly increasing the weight of the rotor. Furthermore, it is possible to provide the centrifuge capable of automatically adjusting the rotational balance according to a change in the weight of the specimen. The rotational balance can be adjusted by moving the adjustment weight toward a rotation center side or a circumferential side such that the center of gravity of the rotor becomes at a rotation center. In addition, by using the solid adjustment weight, a liquid leakage or the need for a complicated configuration for adjusting the center of gravity is eliminated.

### BRIEF DESCRIPTION OF DRAWINGS

FIG. 1 is a perspective view showing the appearance of main parts of a centrifuge according to one embodiment of the invention;

FIG. 2 is an enlarged perspective view showing the appearance of a rotor drive unit and a coupling unit in FIG. 1;

FIG. 3 is a perspective view showing the appearance shown in FIG. 2 when viewed in a front right direction of FIG. 2;

FIG. 4 is a functional block diagram showing main functions of the centrifuge according to the invention; and

FIG. 5 is a flowchart showing an adjustment processing procedure of the invention for adjusting the center of gravity of a rotor according to the weight of a specimen.

### MODE(S) FOR CARRYING OUT THE INVENTION

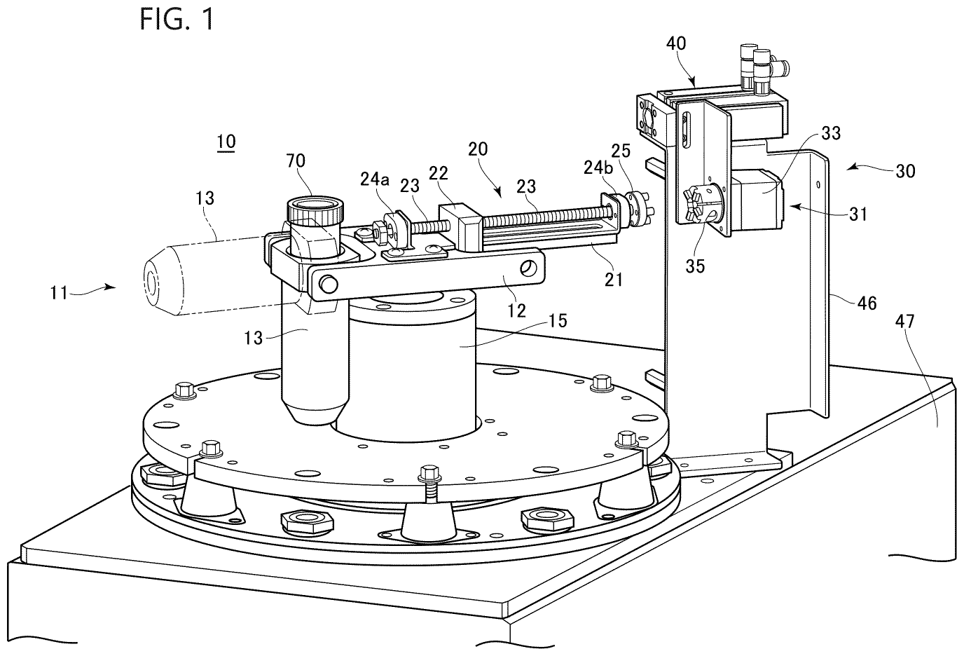

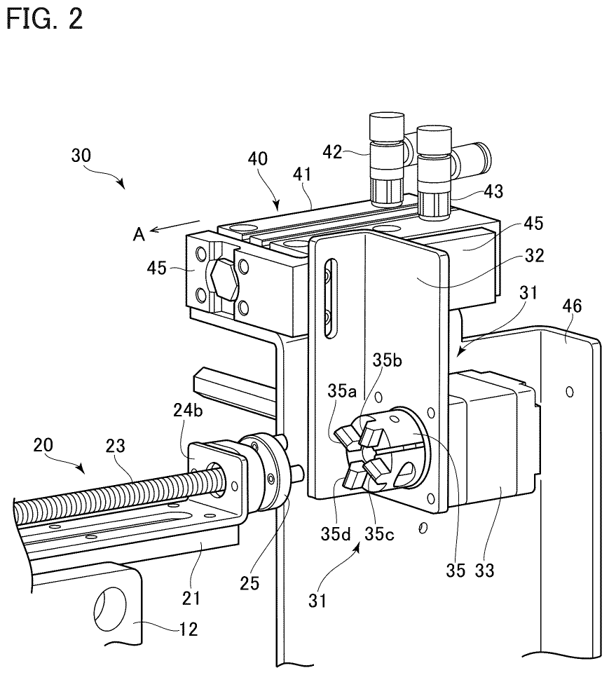

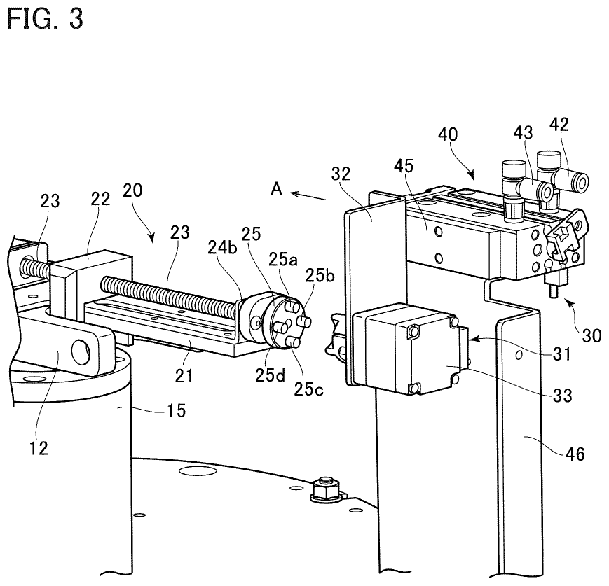

The invention will be described in detail with reference to the drawings. FIG. 1 is a perspective view showing the appearance (with a cover removed) of main parts of a centrifuge according to one embodiment of the invention. FIG. 2 is an enlarged perspective view showing the appearance of a rotor drive unit and a coupling unit in FIG. 1, and FIG. 3 is a perspective view of the appearance of the same parts as FIG. 2, when viewed in a front right direction of FIG. 2.

FIG. 1 shows a state where both a rotor 11 and a center-of-gravity adjustment unit 30 are stopped. A broken line indicates a state where a tube (centrifuge tube) 70 set in the rotor 11 is horizontal due to a centrifugal force caused by the rotation of the rotor 11 (a state during centrifugation). A centrifuge 10 shown in FIG. 1 includes the rotor 11; a rotor drive motor 15 that rotationally drives the rotor 11; and the center-of-gravity adjustment unit 30 that adjusts the rotational balance of the rotor 11.

The rotor 11 is rotationally driven at low to high speed (for example, 400 revolutions to 10000 revolutions/minute) by the rotor drive motor 15 to apply a centrifugal force to the specimen set in the rotor 11, thereby performing centrifugation. The rotor 11 includes a base portion 12; a bucket (specimen storage portion) 13 provided at one end of the base portion 12; and a weight movement mechanism 20 extending toward the other end side of the base portion 12. The bucket 13 is suspended from the one end of the base portion 12 by using a hinge, and the tube (centrifuge tube) 70 containing the specimen is set in the bucket 13.

The weight movement mechanism 20 is provided on the other end side of the base portion 12 of the rotor 11. The weight movement mechanism 20 includes a guide portion 21 fixed to the base portion 12 and extending in a radial direction of the rotor 11, and a solid adjustment weight 22 that is slidably provided on the guide portion 21.

The adjustment weight 22 has a female threaded through-hole (not shown), and a drive shaft 23 having a male threaded outer periphery and extending in the radial direction penetrates through the through-hole in a state where the male thread and the female thread mesh with each other. One end of the drive shaft 23 is rotatably fixed to a guide support portion 24a provided at one end of the guide portion 21, and the other end is rotatably fixed to a guide support portion 24b provided at the other end of the guide portion 21.

Therefore, when the drive shaft 23 rotates, the adjustment weight 22 moves forward or backward by a predetermined amount along the guide portion 21 in the radial direction depending on a rotation direction and a rotation amount of the drive shaft 23. Accordingly, the center of gravity of the rotor 11 moves in the radial direction of rotation of the rotor 11 corresponding to the rotation amount of the drive shaft 23. Rotational balance can be adjusted by changing the center of gravity of the rotor 11 corresponding to the weight of the specimen through controlling the rotation direction and the rotation amount of the drive shaft 23 in such a manner.

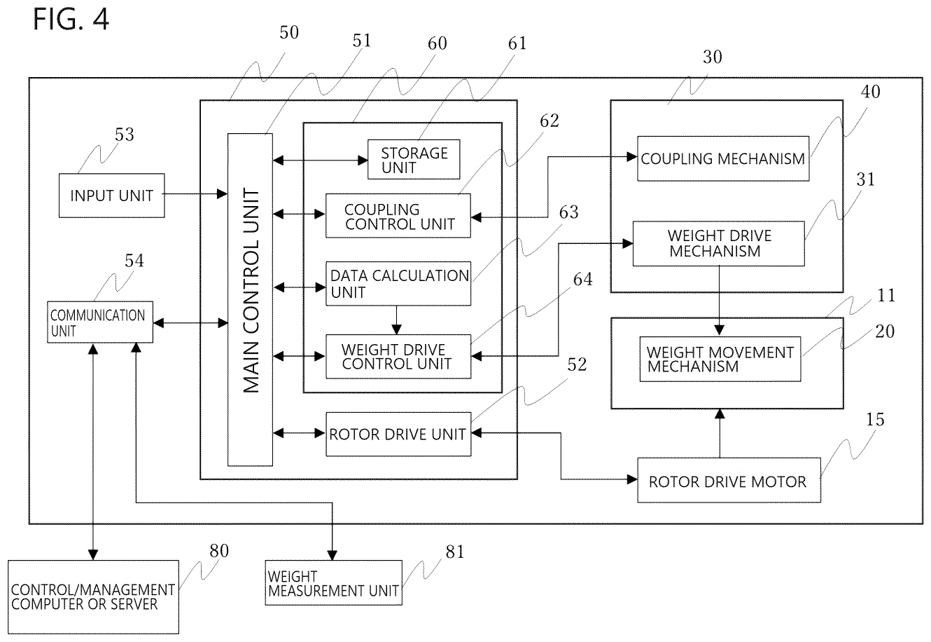

The center-of-gravity adjustment unit 30 is installed away from the rotor 11, and includes a weight drive mechanism 31, a coupling mechanism 40, and a center-of-gravity adjustment control unit 60 (refer to FIG. 4). The weight drive mechanism 31 rotationally drives the drive shaft 23 of the rotor 11 to move the adjustment weight 22 in the radial direction of rotation of the rotor 11, thereby adjusting the rotational balance of the rotor 11. The center-of-gravity adjustment unit 30 is disposed at a position away from the rotor 11, and is retracted to the position away from the rotor 11 during rotation of the rotor 11.

When the center of gravity of the rotor 11 is adjusted by moving the adjustment weight 22 to adjust the rotational balance of the rotor 11, the weight drive mechanism 31 is moved to a rotor 11 side by the coupling mechanism 40 to connect coupling end portions 25 and 35 on the rotor side and a weight drive mechanism 31 side. Thereafter, by rotating the coupling end portion 35 on a drive side of the weight drive mechanism 31, the drive shaft 23 is rotated to adjust the rotational balance of the rotor 11.

First, the weight drive mechanism 31 will be described.

In the centrifuge shown in FIGS. 1 to 3, the weight drive mechanism 31 includes a weight drive motor 33 as a drive source that rotationally drives the coupling end portion 35 on the drive side. The weight drive motor 33 is fixed to a support plate 32 (refer to FIG. 2). When the weight drive motor 33 is driven in a state where the coupling end portions 25 and 35 are connected to each other, the drive shaft 23 connected to the coupling end portion 25 on the connected rotor side rotates forward or reverse depending on the rotation direction of a rotating shaft of the weight drive motor 33. Accordingly, the adjustment weight 22 can move in a direction toward or in a direction away from the center of the rotor 11 in the radial direction of rotation to change the center of gravity of the rotor 11 and adjust the rotational balance.

Since the adjustment weight 22 is a solid weight, the mass and the center of gravity of the adjustment weight itself do not change. Therefore, unlike balance adjustment using a liquid as in Patent Document 2, a balance adjustment using an adjustment weight made of a solid material can be simply calculated from the mass of the adjustment weight and a distance from the rotation center to the center-of-gravity position of the adjustment weight. For that reason, balance adjustment can be easily and accurately performed according to a change in the weight of the specimen set in the bucket.

The coupling mechanism 40 will be described.

The coupling mechanism 40 includes a coupling drive unit 41 and a movable plate 45 having an L shape that is moved forward and backward by the coupling drive unit 41. The movable plate 45 is configured to be movable forward and backward in the direction of the rotor 11. An air cylinder, hydraulic pressure, a motor, or the like can be used as the coupling drive unit 41, however, in the embodiment shown in FIGS. 1 to 3, a configuration using an air cylinder is provided as an example.

A plunger (not shown) provided at a distal end is moved forward by the supply of air from a forward movement air supply pipe 42 to move the movable plate connected to the plunger forward. In addition, a plunger (not shown) is moved backward by the supply of air from a backward movement air supply pipe 43 to move the movable plate 45 backward. The movable plate 45 and the support plate 32 of the weight drive mechanism 31 are fixed with bolts or other fastening mechanism, and as the movable plate 45 moves forward, the weight drive mechanism 31 moves forward and the coupling end portions 35 and 25 are coupled to each other. As the movable plate 45 moves backward, the coupling end portions 35 and 25 of the weight drive mechanism 31 and the rotor 11 are separated from each other.

The coupling end portions 25 and 35 will be described with reference to FIGS. 2 and 3. The coupling end portion 25 on the rotor side (refer to FIG. 3) and the coupling end portion 35 on the drive side (refer to FIG. 2) include four projections (meshing portions) 25a to 25d and 35a to 35d, which engage with each other at least during rotation. In the example shown in FIGS. 2 and 3, the four projections of each coupling end portion are disposed with relatively large gaps provided therebetween to allow both coupling end portions 25 and 35 to be smoothly coupled to each other. It is desirable that all the projections of both the coupling end portions are configured and disposed to come into contact and engage with each other at the same time in both cases of rotation in a forward direction and rotation in a reverse direction during rotational drive. In addition, it is preferable that the projections 25a to 25d or 35a to 35d of at least one of the coupling end portions are inclined such that the width thereof gradually increases with respect to a traveling direction during coupling.

In the embodiment shown in FIGS. 1 to 3, relatively large intervals (gaps, play) are provided between the projections 25a to 25d and between the projections 35a to 35d of the coupling end portions, so that coupling between the coupling projections 25a to 25d on the rotor side and the coupling projections 35a to 35b on the drive side is facilitated. In a case where the projections are disposed with the gaps provided in such a manner, due to the gaps (play), when the weight drive motor 33 starts rotating after coupling, only the weight drive motor 33 idles until the projections engage with each other.

However, the movement distance of the adjustment weight 22 connected to the drive shaft 23 caused by the play is very small, and the influence of the play on adjusting the center of gravity is small. For example, it is assumed that the rotation angle of idling due to the portions of play is 2 degrees and the thread pitch of the drive shaft 23 is 1 mm. In this case, since the adjustment weight 22 moves 1 mm each time the drive shaft 23 rotates 360 degrees, in a case where the idling of the weight drive motor 33 is 2 degrees, the error is 1/180 mm, which is a very small error, so that a big problem is not encountered in adjusting the center of gravity.

In a case where a high accuracy to the extent that this slight error causes a problem in accurately controlling the position of the adjustment weight is required, in order to avoid idling due to such play, the position and size of the projections of both the coupling end portions may be accurately provided such that the projections of both the coupling end portions mesh each other without play therebetween. However, in the case of a configuration in which the projections are accurately coupled to each other with little play during coupling, alignment during coupling becomes difficult.

Various operation controls that make highly accurate position adjustment possible with a predetermined size of play provided to facilitate coupling can also be performed. For example, when the position of the adjustment weight 22 is moved, namely, when the center of gravity is adjusted, by performing operation control such that always, the adjustment weight 22 is returned to a predetermined reference position once and then the drive shaft 23 is rotated in the same direction to adjust the position of the adjustment weight 22, the amount of play is eliminated from the rotation of the weight drive motor 33, so that highly accurate adjustment can be performed.

In the above-described correction control, regarding the reference position, for example, a stopper can be provided at the reference position to mechanically stop the adjustment weight 22 at the reference position. In addition, a sensor can also be provided to detect the reference position. In addition, since the amount of play that occurs when rotational drive is performed in an opposite direction is an eigen value of each device, the amount of play is measured at the time of shipment and is stored as an initial value, and when data such as a movement amount is calculated, the data can be calculated by subtracting the amount of play from a control amount.

Incidentally, in the present embodiment, an embodiment in which the adjustment weight 22 is driven by the weight drive motor 33 has been provided as an example; however, the center-of-gravity position can also be changed by driving the adjustment weight 22 using a hydraulic cylinder, an air pump, or other drive source of the related art. In that case, the shape, configuration, coupling means, and the like of the coupling end portion that match the drive source are required.

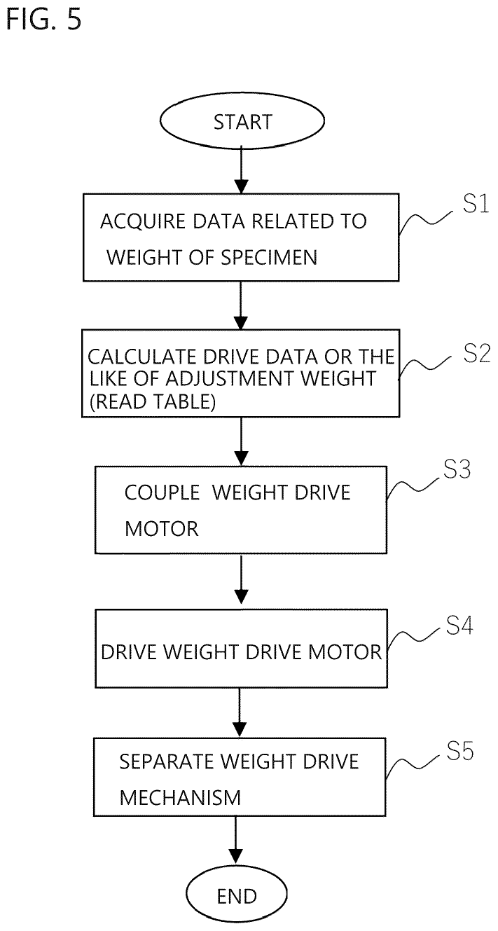

Next, the adjustment of the center of gravity for rotational balance adjustment will be described with reference to FIGS. 4 and 5. FIG. 4 is a functional block diagram functionally representing main parts of mechanisms and control related to the overall control of the centrifuge 10, and FIG. 5 is a flowchart showing one example of center-of-gravity adjustment processing. A control unit 50 receives data regarding centrifugation input from an input unit 53, and controls the overall operation of the centrifuge 10. Incidentally, the centrifuge 10 also includes a sensor that detects the position of the coupling mechanism 40 and other various sensors; however, the description of the various sensors is omitted.

The centrifuge 10 includes the input unit 53, and also includes a communication unit 54 if necessary. The input data input from the input unit is information required for centrifugation processing, such as information regarding centrifugation, for example, data regarding the rotation speed and rotation time of the rotor and the weight of the specimen. The input data may be configured to be input from an external computer 80 or the like via the communication unit 54. In addition, the data regarding the weight of the specimen may be input by measuring the weight of the container 70 containing the specimen and held in the centrifuge 10 using a weight measurement unit 81, and by transmitting the data from the weight measurement unit 81 via wired or wireless communication. The input data is stored in a storage unit 61, and is used for various operations.

The control unit 50 can be configured by a CPU (not shown) and control software that controls the entire device and various types of individual software that controls individual functions, which are stored in the storage unit 61 or other storage unit (not shown), and the like. A main control unit 51 manages control operations of individual control units, such as processing the input data or communication data and driving each part such as a coupling control unit 62, a data calculation unit 63, a weight drive control unit 64, and a rotor drive unit 52.

Hereinafter, one example of an operation and a processing procedure for adjusting the center-of-gravity position of the rotor 11 of the centrifuge provided as an example of one embodiment in FIGS. 1 to 3 will be described using FIGS. 4 and 5.

The main control unit 51 acquires data regarding the weight of the specimen, including the container 70 containing the specimen, from input data input from the input unit 53 or from the computer and the like 80 (including the weight measurement unit 81) (step S1). Thereafter, the center-of-gravity position for maintaining the rotational balance of the rotor 11 during centrifugation processing is calculated from the acquired data, and drive data is calculated (step S2).

In the field of cell culture, the weight of a specimen to be centrifuged and the weight of the container 70 set in the centrifuge differ depending on the type of cells to be cultured. Accordingly, the center of gravity of the rotor is changed, so that rotational balance is disrupted. In order to adjust the rotational balance, it is necessary to move the center of gravity of the rotor 11 to the rotation center of the rotor 11 by changing the position of the adjustment weight 22 on the rotor 11. Since the distance (length) from the rotation center (rotation axis) to the container of the specimen, the weight of the adjustment weight 22, and the center of gravity of the adjustment weight 22 itself are known in advance, the data calculation unit 63 calculates a distance (length) from the rotation center to the center-of-gravity position of the adjustment weight 22 such that the center of gravity of the rotor 11 becomes the rotation center (step S2).

The term “calculate” used herein in the present specification also includes reading and acquiring data from a table recorded in advance. For example, the term “calculate” also includes the case of calculating and storing the movement amount of the adjustment weight 22 from the reference position or the movement position in a table or the like in advance each time the total weight of the specimen to be centrifuged and the container is increased or decreased by 1 g with respect to a reference weight (the unit of increase or decrease can be optionally set depending on the required accuracy), and reading and acquiring the stored movement amount or movement position when weight data regarding a specimen or the like is input. Incidentally, the calculation of drive data or the like (step S2) is not limited to being performed before the coupling operation of the weight drive mechanism, and may be performed at a timing during the operation or at a timing after the coupling operation.

Thereafter, the weight drive motor 33 is rotationally driven by an amount corresponding to the calculated drive data, based on the control of the weight drive control unit 64, to move the position of the adjustment weight 22, and the center-of-gravity position of the rotor 11 is changed such that the center-of-gravity position of the rotor 11 during rotation after the specimen is set becomes the rotation center (step S4). When the movement of the adjustment weight 22 is completed, the weight drive mechanism 31 is separated from the rotor 11 based on the control of the coupling control unit 62 (step S5), and the adjustment of the center-of-gravity position is completed.

Thereafter, the rotor drive motor 15 is driven under the control of the rotor drive unit 52 to rotate the rotor 11 for a predetermined time set based on the input data, thereby performing centrifugation.

In the present specification, an example of a rectangular parallelepiped form is shown as one example of the form of the adjustment weight; however, the invention is not limited thereto. In addition, various drive sources are not limited to the drive sources provided as examples in the specification, and the related art or known drive sources can be used. The invention is not limited thereto, and the shape, configuration, and the like of each part described in the present specification and the drawings are provided as examples, and the shape, configuration, and the like of each part can be changed as appropriate without changing the basic technical concept of the invention.

What is claimed is:

1. A centrifuge comprising:
a rotor rotationally driven around a predetermined axis, supporting a bucket at one end in a radial direction of a rotation around the axis, the bucket holding a container storing a specimen, and supporting a solid adjustment weight to be movable in the radial direction on the other end side in the radial direction, the adjustment weight adjusting a rotational balance by adjusting a center of gravity of the rotor;
a rotor drive motor to rotationally drive the rotor;
a center-of-gravity adjustment unit provided at a position away from the rotor to be selectively coupleable to the rotor, and coupled to drive the adjustment weight to move in the radial direction when the center of gravity is adjusted; and
a control unit to control operations of the center-of-gravity adjustment unit and the rotor drive motor.

2. The centrifuge according to claim 1,
wherein the center-of-gravity adjustment unit includes a weight drive mechanism to drive the adjustment weight in the radial direction, and a coupling mechanism to move the weight drive mechanism to couple or separate the rotor and the weight drive mechanism from each other such that the adjustment weight can be driven, and
the control unit calculates drive data for moving the adjustment weight based on input data regarding a weight of the specimen to be centrifuged, and controls the weight drive mechanism based on the drive data.

3. The centrifuge according to claim 2,
wherein the weight drive mechanism includes a weight drive unit to drive the adjustment weight, and a coupling end portion on a drive side to couple the weight drive unit and the rotor to each other, and
the rotor includes a coupling end portion on a rotor side connected to the coupling end portion on the drive side.

4. The centrifuge according to claim 3,
wherein the weight drive unit is a motor, and the coupling end portion on the drive side is directly or indirectly connected to a rotating shaft of the motor.

5. The centrifuge according to claim 3,
wherein the control unit calculates drive data for moving the adjustment weight to a position where a center-of-gravity position of the rotor when the specimen is set in the rotor coincides with a rotation center of the rotor, and controls a driving of the coupling unit and the weight drive mechanism to couple the weight drive mechanism to the rotor and then to move the adjustment weight to the center-of-gravity position based on the drive data.

6. The centrifuge according to claim 4,
wherein the control unit calculates drive data for moving the adjustment weight to a position where a center-of-gravity position of the rotor when the specimen is set in the rotor coincides with a rotation center of the rotor, and controls a driving of the coupling unit and the weight drive mechanism to couple the weight drive mechanism to the rotor and then to move the adjustment weight to the center-of-gravity position based on the drive data.

7. The centrifuge according to claim 5,
wherein the input data to the control unit is transmitted and input from an external weight measurement unit or an external computer via a wired or wireless communication.

8. The centrifuge according to claim 6,
wherein the input data to the control unit is transmitted and input from an external weight measurement unit or an external computer via a wired or wireless communication.

9. The centrifuge according to claim 5,
wherein as the input data to the control unit, a weight of a container of the specimen when the container is held in the bucket is automatically measured and input to the control unit.

10. The centrifuge according to claim 6,
wherein as the input data to the control unit, a weight of a container of the specimen when the container is held in the bucket is automatically measured and input to the control unit.

11. A method for adjusting a center of gravity of a rotor of a centrifuge including a rotor rotationally driven around a predetermined axis, supporting a bucket at one end in a radial direction of a rotation around the axis, the bucket holding a container storing a specimen, and supporting a solid adjustment weight to be movable in the radial direction on the other end side in the radial direction, the adjustment weight adjusting a rotational balance, a center-of-gravity adjustment unit disposed at a position away from the rotor to be connectable to the rotor, and to move the adjustment weight in any direction of the radial direction, and a control unit to control an operation of the center-of-gravity adjustment unit, the method comprising:
(a) a data input step of inputting data regarding a weight of the container storing the specimen;
(b) a calculation step of calculating a movement amount of the adjustment weight based on the data;
(c) a step of connecting the center-of-gravity adjustment unit to the rotor before both or one of the step (a) and the step (b) is executed, after the execution, or during the execution; and
(d) an adjustment step of adjusting a center-of-gravity position of the rotor by moving the adjustment weight based on the movement amount calculated in the step (b) after all the steps (a) to (c) are executed.

12. The method for adjusting a center of gravity of a rotor of a centrifuge according to claim 11,
wherein in the step (a), the data regarding the weight is input from an external weight measurement unit or an external computer via a wired or wireless communication.
